(19) United States
(12) Patent Application Publication
(10) Pub. No.: US 2025/0022260 A1
(43) Pub. Date: Jan. 16, 2025

(54) LEARNING MODEL BUILDING DEVICE, PREDICTION DEVICE, LEARNING MODEL BUILDING METHOD, PREDICTION METHOD, AND PROGRAM

(71) Applicant: NIPPON TELEGRAPH AND TELEPHONE CORPORATION, Tokyo (JP)

(72) Inventors: Kazuaki WATANABE, Tokyo (JP); Daisuke UCHIBORI, Tokyo (JP); Yosuke SAKURADA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/714,563

(22) PCT Filed: Dec. 2, 2021
(86) PCT No.: PCT/JP2021/044362

§ 371 Date: May 29, 2024

(51) Int. Cl. G06V 10/776; G06T 7/60; G06V 10/774; G06V 10/82; G06V 10/98

(52) U.S. Cl. CPC G06V 10/776; G06T 7/60; G06V 10/774; G06V 10/993; G06T 2207/20081; G06T 2207/20084; G06T 2207/30184; G06V 10/82

(57) ABSTRACT

A learning model construction device (3A) according to the present disclosure includes: a plurality of learning units (354-k) that constructs a respective plurality of learning models by using a respective plurality of loss functions different from each other on the basis of teacher data in which image data indicating a learning image is associated with a true value of a scale of the learning image; a plurality of verification units (355-k) that respectively calculates, for an optimal verification image, a plurality of estimated values; a plurality of correlation calculation units (356-k) that calculates respective correlations of the true value with the plurality of estimated values of the scale; and an optimal learning model selection unit (357) that selects an optimal learning model that is a learning model of which a corresponding one of the correlations is the highest.

### TECHNICAL FIELD

The present disclosure relates to a learning model construction device, an estimation device, a learning model construction method, an estimation method, and a program.

### BACKGROUND ART

In recent years, it is known to detect an image of an object from an image by using an image processing technique. In particular, by using a method such as segmentation, it is also possible to detect an image of an object from an image on a pixel-by-pixel basis. Methods for improving efficiency of inspection and diagnosis of a structure as an object by utilizing a technique for detecting an image of an object as described above have been studied and developed. For example, in a case where the object is a concrete structure, it is known to diagnose deterioration of the concrete structure by detecting damage such as cracks and exposure of reinforcing bars generated on a surface of the concrete structure.

Further, it is known to quantitatively evaluate a size (area, length, or the like) of a damaged portion in a structure by determining a scale (the unit is “cm/pixel” or “pixel/cm”) of an image indicating an image of the structure in which damage is detected. For example, Non Patent Literature 1 proposes to estimate a scale of an image obtained by capturing an image of a surface of a concrete structure by using deep learning by convolutional neural network (CNN). Specifically, it has been proposed to estimate a scale of an image on the basis of a feature of texture formed by unevenness, shadow, void, or the like on a surface of a concrete structure such as a pedestrian bridge or a concrete wall.

### CITATION LIST

### Non Patent Literature

Non Patent Literature 1: Ju An Park, and two others, “Learning-based image scale estimation using surface texture for quantitative visual inspection of regions-of interest”, Computer-Aided Civil and Infrastructure engineering, Vol. 36, pp. 227-241, 2020

### SUMMARY OF INVENTION

### Technical Problem

However, for example, in an environment in which a surface of a concrete structure is disposed indoors, such as the inside of a communication tunnel, an amount of light is smaller than that in an outdoor environment. For that reason, noise may occur in an image obtained by imaging the concrete structure by a camera indoors. Such noise may make it difficult to estimate with high accuracy a scale of an image obtained by capturing an image of the surface of the concrete structure.

An object of the present disclosure made in view of such circumstances is to provide a learning model construction device, an estimation device, a learning model construction method, an estimation method, and a program capable of estimating a scale of a surface of a concrete structure with high accuracy.

### Solution to Problem

To solve the above problem, a learning model construction device according to the present disclosure includes: a plurality of learning units that constructs a respective plurality of learning models by using a respective plurality of loss functions different from each other on the basis of teacher data in which image data indicating a learning image obtained by imaging a surface of concrete and of which a true value of a scale is known is associated with the true value of the scale of the learning image; a plurality of verification units that calculates, for an optimal verification image of which a true value of a scale is known and that is different from the learning image, a respective plurality of estimated values of the scale by using the respective plurality of learning models; a plurality of correlation calculation units that calculates, for the optimal verification image, respective correlations of the plurality of estimated values of the scale with the true value of the scale; and an optimal learning model selection unit that selects an optimal learning model that is a learning model of which a corresponding one of the correlations is the highest among the plurality of learning models.

In addition, to solve the above problem, an estimation device according to the present disclosure includes: a learning model storage unit that stores the optimal learning model selected by the learning model construction device; and an estimation unit that calculates an estimated value of a scale of an unknown image of which the true value of the scale is unknown by using the optimal learning model.

In addition, to solve the above problem, a learning model construction method according to the present disclosure includes: a step of constructing a respective plurality of learning models by using a respective plurality of loss functions different from each other on the basis of teacher data in which image data indicating a learning image obtained by imaging a surface of concrete and of which a true value of a scale is known is associated with the true value of the scale of the learning image; a step of calculating, for an optimal verification image of which a true value of a scale is known and that is different from the learning image, a respective plurality of estimated values of the scale by using the respective plurality of learning models; a step of calculating, for the optimal verification image, respective correlations of the plurality of estimated values of the scale with the true value of the scale; and a step of selecting an optimal learning model that is a learning model of which a corresponding one of the correlations is the highest among the plurality of learning models.

In addition, to solve the above problem, an estimation method according to the present disclosure is an estimation method executed by an estimation device including a learning model storage unit that stores the optimal learning model selected by the learning model construction device, and includes a step of calculating an estimated value of a scale of an unknown image of which the true value of the scale is unknown by using the optimal learning model.

In addition, to solve the above problem, a program according to the present disclosure causes a computer to function as the learning model construction device described above.

### Advantageous Effects of Invention

According to the learning model construction device, the estimation device, the learning model construction method, the estimation method, and the program according to the present disclosure, it is possible to estimate a scale of a surface of a concrete structure with high accuracy.

### BRIEF DESCRIPTION OF DRAWINGS

FIG. 1 is a schematic diagram illustrating an example of an estimation system according to a first embodiment.

FIG. 2 is a schematic diagram illustrating an example of a model construction unit illustrated in FIG. 1.

FIG. 3 is a schematic diagram illustrating an example of a scale estimation unit illustrated in FIG. 1.

FIG. 4 is a schematic diagram illustrating another example of the estimation system according to the first embodiment.

FIG. 5 is a sequence diagram illustrating an example of an operation for storing teacher data in the estimation device illustrated in FIG. 1.

FIG. 6 is a sequence diagram illustrating an example of an operation for constructing a learning model in the estimation device illustrated in FIG. 1.

FIG. 7 is a sequence diagram illustrating a first example that is details of the operation illustrated in FIG. 6.

FIG. 8 is a sequence diagram illustrating a second example that is details of the operation illustrated in FIG. 6.

FIG. 9 is a sequence diagram illustrating an example of an operation for calculating an estimated value of a scale in the estimation device illustrated in FIG. 1.

FIG. 10 is a schematic diagram illustrating an estimation system according to a second embodiment.

FIG. 11 is a schematic diagram illustrating another example of the estimation system according to the second embodiment.

FIG. 12 is a sequence diagram illustrating an example of an operation for storing teacher data in the estimation device illustrated in FIG. 10.

FIG. 13 is a sequence diagram illustrating an example of an operation for calculating an estimated value of a scale in the estimation device illustrated in FIG. 10.

FIG. 14 is a schematic diagram illustrating an example of an estimation system according to a third embodiment.

FIG. 15 is a schematic diagram illustrating an example of a noise image removal unit illustrated in FIG. 14.

FIG. 16A is a diagram illustrating an example of frequency distribution of pixel values of an a* component in an image including color noise.

FIG. 16B is a diagram illustrating an example of the frequency distribution of the pixel values of the a* component in an image not including color noise.

FIG. 17A is a diagram illustrating an example of frequency distribution of pixel values of a b* component in an image including color noise.

FIG. 17B is a diagram illustrating an example of the frequency distribution of the pixel values of the b* component in an image not including color noise.

FIG. 18 is a schematic diagram illustrating another example of the estimation system according to the third embodiment.

FIG. 19 is a sequence diagram illustrating an example of an operation for storing teacher data in the estimation device illustrated in FIG. 14.

FIG. 20 is a sequence diagram illustrating an example of an operation for calculating an estimated value of a scale in the estimation device illustrated in FIG. 14.

FIG. 21 is a hardware block diagram of an estimation device and a learning model construction device.

### DESCRIPTION OF EMBODIMENTS

### First Embodiment

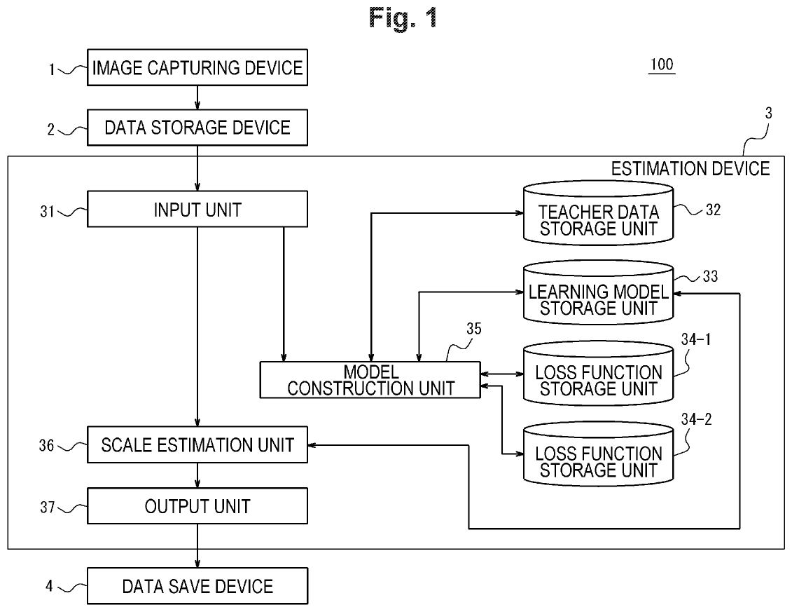

An overall configuration of a first embodiment will be described with reference to FIGS. 1 to 3.

As illustrated in FIG. 1, an estimation system 100 according to the first embodiment includes an image capturing device 1, a data storage device 2, an estimation device 3, and a data save device 4.

### <Configuration of Image Capturing Device>

The image capturing device 1 may include a camera including an optical element, an image capturing element, and an output interface. The output interface is an interface for outputting image data indicating an image captured by the image capturing element.

The image capturing device 1 generates an image obtained by capturing an image of a subject. The subject can be a surface of concrete. The concrete can be one that forms, for example, a pedestrian bridge, a wall surface, a paved road, and the like. On the surface of the subject, a surface pattern is represented, and aggregate may be exposed. In addition, a format of the image may be any format, and may be, for example, a JPG format or a PNG format.

In addition, the image capturing device 1 outputs image data indicating an image to the data storage device 2.

### <Configuration of Data Storage Device>

The data storage device 2 may include a computer including a memory, a controller, an input interface, and an output interface. The memory may include a hard disk drive (HDD), a solid-state drive (SSD), an electrically erasable programmable read-only memory (EEPROM), a read-only memory (ROM), a random access memory (RAM), and the like. The controller may include dedicated hardware such as an application specific integrated circuit (ASIC) or a field-programmable gate array (FPGA), may include a processor, or may include both the dedicated hardware and the processor. The input interface can be a pointing device, a keyboard, a mouse, or the like. In addition, the input interface may be an interface that receives input of information received by a communication interface. For the communication interface, a standard such as Ethernet (registered trademark), fiber distributed data interface (FDDI), or Wi-Fi (registered trademark) may be used, for example.

The data storage device 2 receives input of image data output by the image capturing device 1, and stores the image data. In addition, the data storage device 2 outputs image data to the estimation device 3.

### <Configuration of Estimation Device>

The estimation device 3 includes an input unit 31, a teacher data storage unit 32, a learning model storage unit 33, loss function storage units 34-k (k=1 to n, n is an integer greater than or equal to 2), a model construction unit 35, a scale estimation unit 36, and an output unit 37. In the example illustrated in FIG. 1, n=2 is set. The input unit 31 includes an input interface. The teacher data storage unit 32, the learning model storage unit 33, and the loss function storage units 34-k each include a memory. The model construction unit 35 and the scale estimation unit 36 each include a controller. The output unit 37 includes an output interface.

The input unit 31 receives input of image data output from the data storage device 2. The input unit 31 may receive input of image data from the image capturing device 1 without intervention of the data storage device 2.

Specifically, the input unit 31 may receive input of teacher data in which image data indicating an image of which a true value of a scale is known is associated with a true value yₜᵣᵤₑ of the scale of the image indicated by the image data. The image of which the true value of the scale is known includes a learning image, a learning verification image, and an optimal verification image, and the learning image, the learning verification image, and the optimal verification image are images different from each other. In addition, the input unit 31 receives input of image data indicating an unknown image of which the true value yₜᵣᵤₑ of the scale is unknown.

The scale is a value indicating a ratio between a length of one pixel in an image and a length in a real space, and may be the length (cm/pixel) in the real space with respect to the length of one pixel, or may be the length (pixel/cm) of one pixel with respect to the length in the real space.

The teacher data storage unit 32 stores teacher data in which image data indicating an image of which the true value yₜᵣᵤₑ of the scale is known is associated with the true value yₜᵣᵤₑ of the scale of the image. Specifically, the teacher data storage unit 32 may store teacher data of which the input unit 31 receives input. In addition, the teacher data storage unit 32 may store teacher data in which the image data of which the input unit 31 receives input is associated with the true value yₜᵣᵤₑ of the scale calculated by a scale calculation unit 351 to be described in detail later. In addition, the teacher data storage unit 32 may store teacher data in which image data of which the input unit 31 receives input and that indicates an image processed by a data processing unit 352 to be described in detail later is associated with the true value yₜᵣᵤₑ of the scale of the image.

Images stored by the teacher data storage unit 32 include a learning image, a learning verification image, and an optimal verification image.

The learning model storage unit 33 stores a learning model for calculating an estimated value y_{pred} of a scale of an image indicated by image data when the image data is input. In addition, when learning models are constructed by respective learning units 354-k to be described in detail later, the learning model storage unit 33 stores each of the learning models constructed. In addition, the learning model storage unit 33 stores an optimal learning model to be described in detail later. The learning model may be any model, and can be, for example, a deep learning model. In addition, the learning model is configured to output one estimated value y_{pred} for the scale when one piece of image data is input.

The plurality of loss function storage units 34-k store respective loss functions (parameters set for the loss functions) different from each other. Each loss function is a function for calculating a loss value L in N pieces of image data i (i=1 to N, N is an integer). The loss value L is a value for evaluating accuracy of the learning model, based on an error of an estimated value y_{pred, i} of the scale with respect to a true value y_{true, i} of the scale. The loss function can be, for example, a function shown in Formulas (1) to (4). In Formulas (1) and (2), a is a coefficient set in advance.

$$\begin{matrix}[ Math . 1 ] & \\ L = \frac{1}{N} {\sum }_{i = 1}^{N} α \vert {y}_{true , i} - {y}_{pred , i} \vert + \frac{\vert {y}_{true , i} - {y}_{pred , i} \vert}{{y}_{true , i}} \times 100 & ( 1 )\end{matrix}$$

The loss value L calculated by a loss function shown in Formula (1) is a total value of a mean absolute error (MAE) of the estimated value y_{pred, i} with respect to the true value y_{true, i} and a mean absolute percentage error (MAPE) of the estimated value y_{pred, i} with respect to the true value y_{true, i}. For that reason, with use of the loss function shown in Formula (1), a value of the mean absolute error is considered in addition to the mean absolute percentage error between the true value y_{true, i} and the estimated value y_{pred, i}. For that reason, as the true value y_{true, i} of the scale increases, the loss value L increases. In addition, in a case where the estimated value y_{pred, i} of the scale becomes an outlier greatly deviating from the true value y_{true, i}, the loss value L increases.

$$\begin{matrix}[ Math . 2 ] & \\ L = \frac{1}{N} {\sum }_{i = 1}^{N} {α ( {y}_{true , i} - {y}_{pred , i} )}^{2} + \frac{\vert {y}_{true , i} - {y}_{pred , i} \vert}{{y}_{true , i}} \times 100 & ( 2 )\end{matrix}$$

The loss value L calculated by a loss function shown in Formula (2) is a total value of a mean square error of the estimated value y_{pred, i} with respect to the true value y_{true, i} and a mean absolute percentage error of the estimated value y_{pred, i} with respect to the true value y_{true, i}. With use of the loss function shown in Formula (2), the loss value L can show a tendency similar to that in the case of using the loss function shown in Formula (1), and is larger than that in the case of using the loss function shown in Formula (1) with respect to the outlier. In addition, the first term of Formula (2) indicates variance of the estimated value y_{pred, i} with respect to the true value y_{true, i}, and the loss value L increases as the number of imaged data having a large difference between the estimated value y_{pred, i} and the true value y_{true, i} increases. For this reason, in a case where the estimated value y_{pred, i} greatly deviates from the true value y_{true, i}, each learning unit 354-k can further increase the loss with respect to the estimated value y_{pred, i} deviating more greatly. The second term shown in Formula (2) can reflect the magnitude of the outlier to be larger in the loss value L as compared with the first term shown in Formula (2).

$$\begin{matrix}[ Math . 3 ] & \\ L = \frac{1}{N} {\sum }_{i = 1}^{N} \frac{\vert {y}_{true , i} - {y}_{pred , i} \vert}{{y}_{true , i}} \times 100 & ( 3 )\end{matrix}$$

The loss value L calculated by a loss function shown in Formula (3) is a mean absolute percentage error of the estimated value y_{pred, i} with respect to the true value y_{true, i}. With use of the loss function shown in Formula (3), the loss value L is expressed by a mean absolute percentage error. For this reason, the loss value L can indicate a rate of the error between the true value y_{true, i} and the estimated value y_{pred, i} with respect to the true value y_{true, i} without depending on the magnitude of the estimated value y_{pred, i} of the scale. As a result, the loss function shown in Formula (3) can be used without requiring work for setting the coefficient α as in the loss functions shown in Formulas (1) and (2).

$$\begin{matrix}[ Math . 4 ] & \\ L = \frac{1}{N} {\sum }_{i = 1}^{N} \frac{\vert {y}_{true , i} - {y}_{pred , i} \vert}{{y}_{pred , i}} \times 100 & ( 4 )\end{matrix}$$

The loss value L calculated by a loss function shown in Formula (4) is a value obtained by replacing the denominator of the mean absolute percentage error in the loss function shown in Formula (1) with the estimated value y_{pred, i} from the true value y_{true, i}. With use of the loss function shown in Formula (4), the loss value L can be changed depending on a magnitude relationship between the estimated value y_{pred, i} and the true value y_{true, i}. For example, in a case where the estimated value y_{pred, i} is smaller than the true value y_{true, i}, the loss value L changes more greatly than in a case where the estimated value y_{pred, i} is larger than the true value y_{true, i}.

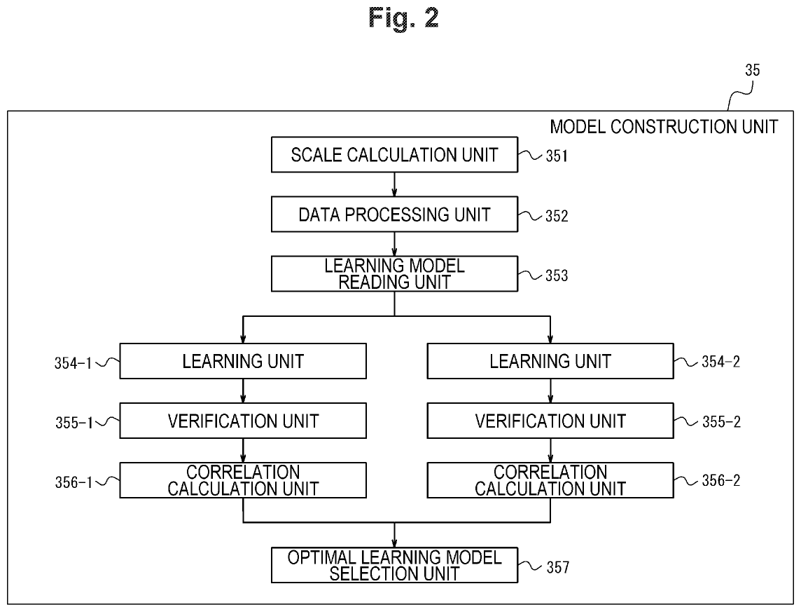

As illustrated in FIG. 2, the model construction unit 35 includes the scale calculation unit 351, the data processing unit 352, a learning model reading unit 353, the learning units 354-k, verification units 355-k, correlation calculation units 356-k, and an optimal learning model selection unit 357.

The scale calculation unit 351 calculates the true value y_{true, i} of the scale of an image indicated by image data of which the input unit 31 receives input.

Specifically, the scale calculation unit 351 may calculate the true value y_{true, i} of the scale on the basis of a length in an image space of an image of a measure of which a dimension in the real space is known, included in the image indicated by the image data, and a length in the real space of the measure. In addition, the scale calculation unit 351 may calculate the true value y_{true, i} of the scale by using a known library such as an augmented reality (AR) marker included in the image indicated by the image data. Note that, not limited to these methods, the scale calculation unit 351 can calculate the true value y_{true, i} of the scale by any method.

The data processing unit 352 processes image data indicating an image for which the true value y_{true, i} of the scale is calculated by the scale calculation unit 351. Specifically, the data processing unit 352 may change the size of the image data, or may change the format.

For example, the data processing unit 352 can generate a plurality of images by dividing the image indicated by the image data. As a result, the learning units 354-k to be described in detail later can perform learning with a plurality of pieces of image data indicating a respective plurality of images as teacher data, and can efficiently generate highly accurate learning models as compared with a case where learning is performed with one piece of image data as teacher data.

In addition, the data processing unit 352 can convert a shape of the image indicated by the image data into a square, and create a rotated image obtained by rotating a square image converted into the square, an inverted image obtained by inverting the square image, and the like. As a result, the learning units 354-k can perform learning with a plurality of pieces of image data respectively indicating a plurality of patterns of images as teacher data, and can efficiently generate highly accurate learning models as compared with a case where learning is performed with one piece of image data as teacher data. In addition, in a case where the image indicated by the image data includes an image of a subject other than the concrete structure, the data processing unit 352 may process the image data to remove pixels indicating the image.

The data processing unit 352 causes the teacher data storage unit 32 to store teacher data in which the processed image data is associated with the true value y_{true, i} of the scale of the image indicated by the image data before processing.

The learning model reading unit 353 reads a learning model stored in the learning model storage unit 33. In addition, the learning model reading unit 353 reads image data and the true value y_{true, i} of the scale of the image indicated by the image data, which are associated with each other as the teacher data and stored in the teacher data storage unit 32.

The plurality of learning units 354-k constructs a respective plurality of learning models by using a respective plurality of loss functions different from each other on the basis of teacher data in which image data indicating a learning image obtained by imaging a surface of concrete and of which a true value y_{true, i} of a scale is known is associated with the true value y_{true, i} of the scale of the learning image. For example, in a configuration in which n=2 is set, the learning unit 354-1 constructs a learning model by using a loss function stored in the loss function storage unit 34-1. The learning unit 354-2 constructs a learning model by using a loss function stored in the loss function storage unit 34-2.

Specifically, the plurality of learning units 354-k respectively performs learning of the plurality of learning models, and calculates, for a learning verification image of which a true value y_{true, i} of a scale is known and that is different from the learning image and the optimal verification image, estimated values y_{pred, i} of the scale by using the respective plurality of learning models. Then, the plurality of learning units 354-k constructs the learning models on the basis of loss values L calculated by the loss functions by using the plurality of estimated values y_{pred, i} of the scale for the learning verification image and the true value y_{true, i} of the scale for the learning verification image.

For example, in a configuration in which the learning model is a CNN, each learning unit 354-k constructs a learning model on the basis of a deep learning model read by the learning model reading unit 353, a learning image indicated by image data, and the true value y_{true, i} of the scale. Then, the learning unit 354-k performs convolution of the learning verification image to calculate the estimated value y_{pred, i} of the scale. Then, the learning unit 354-k constructs a learning model (weight file) in which a weight parameter is adjusted to cause the loss value L calculated on the basis of the true value y_{true, i} and the estimated value y_{pred, i} of the learning verification image to be a minimum value. In addition, the learning unit 354-k causes the learning model storage unit 33 to store the constructed learning model.

The plurality of verification units 355-k calculates, for an optimal verification image of which a true value y_{true, i} of a scale is known and that is different from the learning image, a respective plurality of estimated values y_{pred, i} of the scale by using the respective plurality of learning models. For example, in the configuration in which n=2 is set, the verification unit 355-1 calculates the estimated value y_{pred, i} of the scale by using the learning model constructed by the learning unit 354-1. The verification unit 355-2 calculates the estimated value y_{pred, i} of the scale by using the learning model constructed by the learning unit 354-2. The verification units 355-k preferably calculates the estimated values y_{pred, i} of the scale of a plurality of images, respectively.

The plurality of correlation calculation units 356-k calculates respective correlations of the plurality of estimated values y_{pred, i} of the scale with respect to the true value y_{true, i} of the scale for the optimal verification image. The correlations can be indexes such as correlation coefficients or determination coefficients. For example, in the configuration in which n=2 is set, the correlation calculation unit 356-1 calculates a correlation of the estimated value y_{pred, i} calculated by the verification unit 355-1 with respect to the true value y_{true, i}. The correlation calculation unit 356-2 calculates a correlation of the estimated value y_{pred, i} calculated by the verification unit 355-2 with respect to the true value y_{true, i}.

The optimal learning model selection unit 357 selects an optimal learning model that is a learning model having the highest correlation among the plurality of learning models. For example, in the configuration in which n=2 is set, the optimal learning model selection unit 357 selects, as the optimal learning model, a learning model having the highest correlation out of the correlation calculated by the correlation calculation unit 356-1 and the correlation calculated by the correlation calculation unit 356-2.

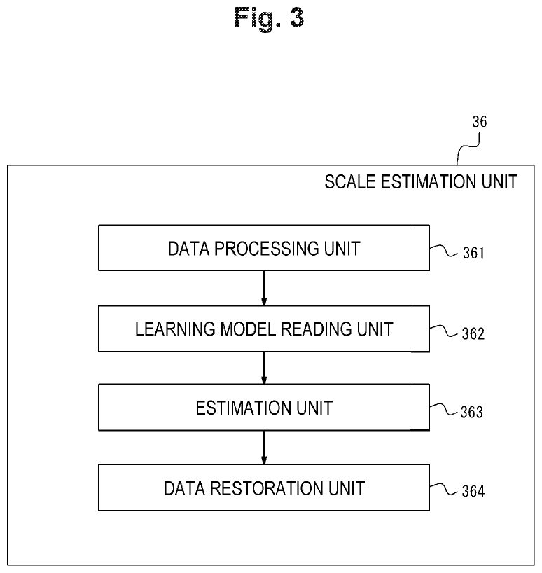

As illustrated in FIG. 3, the scale estimation unit 36 includes a data processing unit 361, a learning model reading unit 362, an estimation unit 363, and a data restoration unit 364.

The data processing unit 361 processes the image data indicating the unknown image input by the input unit 31. Details of processing executed by the data processing unit 361 are similar to details of processing executed by the data processing unit 352.

The learning model reading unit 362 reads the optimal learning model selected by the optimal learning model selection unit 357 and stored in the learning model storage unit 33.

The estimation unit 363 calculates an estimated value y_{pred, i} of the scale of the unknown image of which the true value y_{true, i} of the scale is unknown by using the optimal learning model.

The data restoration unit 364 restores the image data processed by the data processing unit 361.

For example, in a case where the unknown image indicated by the image data input by the input unit 31 is divided by the data processing unit 361, the data restoration unit 364 restores the image data by performing processing to restore divided images to the unknown image before division. In this case, the data restoration unit 364 may calculate a representative value of estimated values y_{pred, i} of the scale calculated for the respective divided images as the estimated value y_{pred, i} of the scale of the unknown image indicated by the restored image data. The representative value can be a statistic such as a mean value or a median value.

In addition, in a case where the size of the unknown image indicated by the image data of which the input unit 31 receives input is changed by the data processing unit 361, the data restoration unit 364 restores the image data by performing processing to restore the image of which the size is changed to the unknown image before division.

The output unit 37 outputs scale estimation information including image data and an estimated value y_{pred, i} of the scale of the image indicated by the image data. Specifically, the output unit 37 may output the scale estimation information to the data save device 4 via a communication network. The output unit 37 may output the scale estimation information to a display device including an organic electro-luminescence (EL), a liquid crystal panel, or the like.

### <Configuration of Data Save Device>

The data save device 4 illustrated in FIG. 1 includes a computer including a memory, a controller, and an input interface. The data save device 4 stores the scale estimation information output from the estimation device 3.

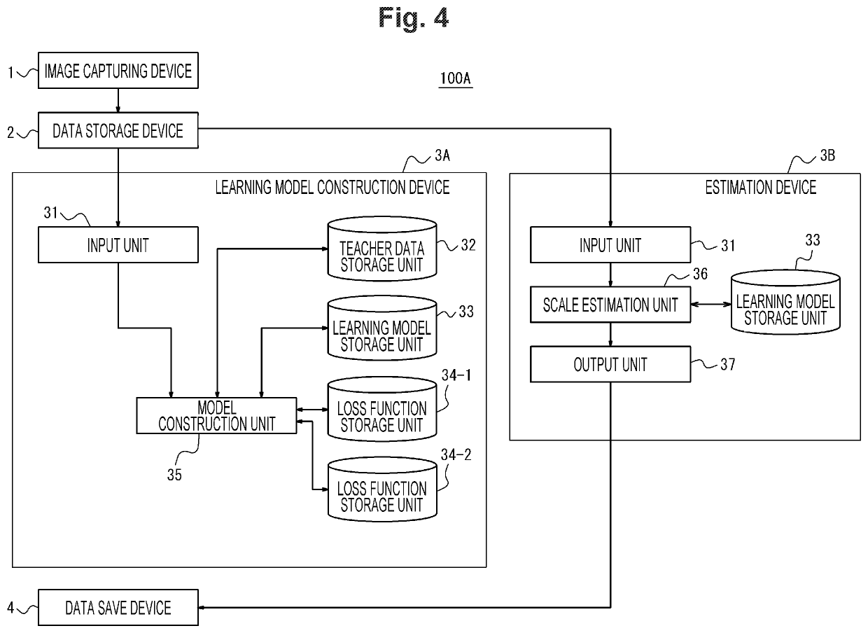

Note that, as illustrated in FIG. 4, an estimation system 100A of another example of the first embodiment includes the image capturing device 1, the data storage device 2, a learning model construction device 3A, an estimation device 3B, and the data save device 4. In the estimation system 100A, the learning model construction device 3A includes the input unit 31, the teacher data storage unit 32, the learning model storage unit 33, the loss function storage unit 34-k, and the model construction unit 35. In addition, the estimation device 3B includes the input unit 31, the learning model storage unit 33, the scale estimation unit 36, and the output unit 37. Note that, in the estimation system 100A, functional units denoted by the same reference numerals as those of the estimation system 100 have the same functions. However, in the estimation system 100A, the learning model storage unit 33 included in the estimation device 3B stores an optimal learning model selected by the learning model construction device 3A.

### <Operation of Estimation Device>

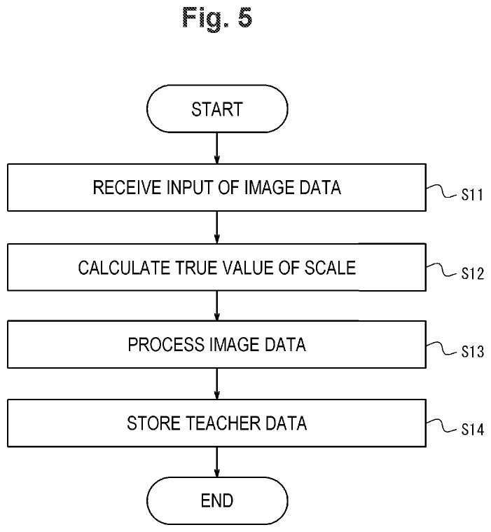

Here, operation of the estimation device 3 according to the first embodiment will be described with reference to FIGS. 5 to 9. FIGS. 5 to 9 are flowcharts illustrating an example of the operation of the estimation device 3 according to the first embodiment. The operation of the estimation device 3 described with reference to FIGS. 5 to 9 corresponds to an example of an estimation method executed by the estimation device 3 according to the first embodiment.

### (Storage of Teacher Data)

With reference to FIG. 5, a description will be given of a method in which the estimation device 3 stores teacher data.

In step S11, the input unit 31 receives input of image data output from the data storage device 2.

In step S12, the scale calculation unit 351 calculates a true value y_{true, i} of a scale of an image indicated by the image data.

In step S13, the data processing unit 352 processes the image data.

In step S14, the teacher data storage unit 32 stores teacher data in which the image data processed in step S13 is associated with the true value y_{true, i} of the scale of the image calculated in step S12.

### (Construction of Learning Model)

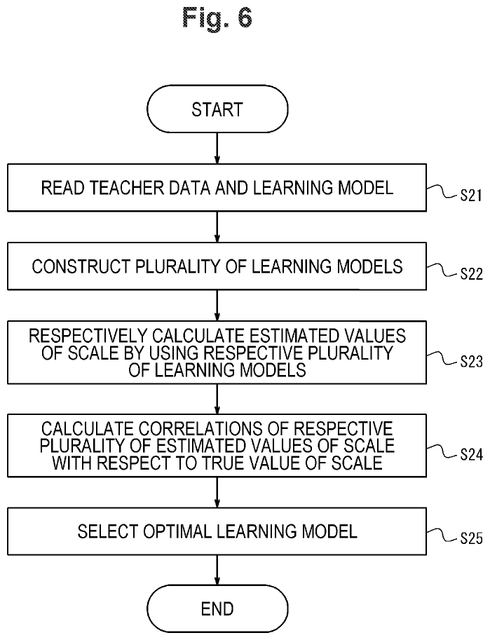

With reference to FIG. 6, a description will be given of a method in which the estimation device 3 constructs a learning model.

In step S21, the learning model reading unit 353 reads teacher data stored in the teacher data storage unit 32. In addition, the learning model reading unit 353 reads a learning model from the learning model storage unit 33.

In step S22, the plurality of learning units 354-k constructs a respective plurality of learning models by using a respective plurality of loss functions different from each other on the basis of teacher data in which image data indicating a learning image obtained by imaging a surface of concrete and of which a true value y_{true, i} of a scale is known is associated with the true value y_{true, i} of the scale of the learning image.

In step S23, the plurality of verification units 355-k calculates, for an optimal verification image of which a true value y_{true, i} of a scale is known and that is different from the learning image, a respective plurality of estimated values y_{pred, i} of the scale by using the respective plurality of learning models.

In step S24, the plurality of correlation calculation units 356-k calculates respective correlations of the plurality of estimated values y_{pred, i} of the scale with respect to the true value y_{true, i} of the scale for the optimal verification image.

In step S25, the optimal learning model selection unit 357 selects an optimal learning model that is a learning model having the highest correlation among the plurality of learning models.

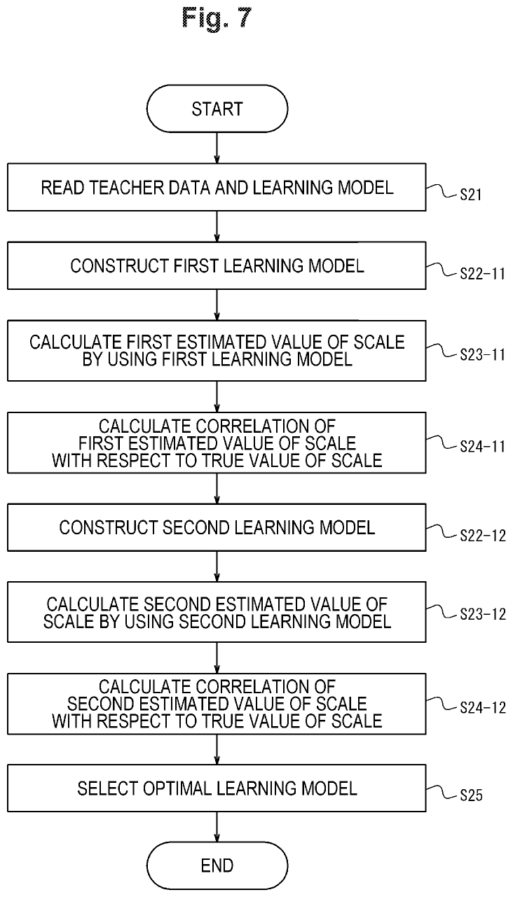

Here, with reference to FIG. 7, a detailed description will be given of a first example of the method in which the estimation device 3 constructs a learning model in the configuration in which n=2 is set.

As illustrated in FIG. 7, in step S21, the learning model reading unit 353 reads teacher data stored in the teacher data storage unit 32. In addition, the learning model reading unit 353 reads a learning model from the learning model storage unit 33.

In step S22-11, the learning unit 354-1 constructs a first learning model by using a first loss function on the basis of the teacher data in which the learning image obtained by imaging the surface of the concrete and of which the true value y_{true, i} of the scale is known is associated with the true value y_{true, i} of the scale of the learning image.

In step S23-11, the verification unit 355-1 calculates, for the optimal verification image of which the true value y_{true, i} of the scale is known and that is different from the learning image, a first estimated value y_{pred, i} of the scale by using the first learning model.

In step S24-11, the correlation calculation unit 356-1 calculates a correlation of the first estimated value y_{pred, i} of the scale with respect to the true value y_{true, i} of the scale for the optimal verification image.

Subsequently, in step S22-12, the learning unit 354-2 constructs a second learning model by using a second loss function on the basis of the teacher data in which the learning image obtained by imaging the surface of the concrete and of which the true value y_{true, i} of the scale is known is associated with the true value y_{true, i} of the scale of the learning image.

In step S23-12, the verification unit 355-2 calculates, for the optimal verification image of which the true value y_{true, i} of the scale is known and that is different from the learning image, a second estimated value y_{pred, i} of the scale by using the second learning model.

In step S24-12, the correlation calculation unit 356-2 calculates a correlation of the second estimated value y_{pred, i} of the scale with respect to the true value y_{true, i} of the scale for the optimal verification image.

In step S25, the optimal learning model selection unit 357 selects an optimal learning model that is a learning model having the highest correlation among the plurality of learning models.

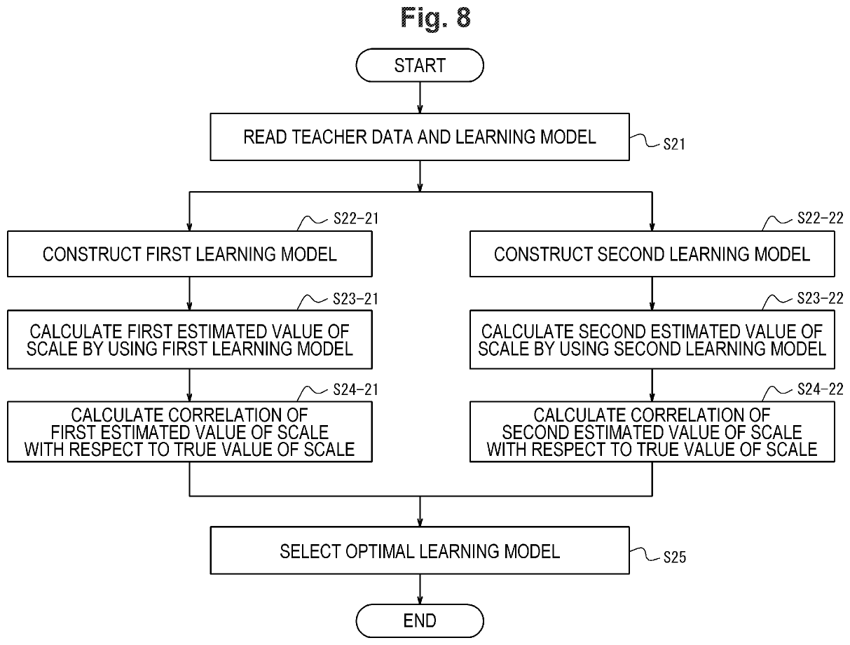

Next, with reference to FIG. 8, a detailed description will be given of a second example of the method in which the estimation device 3 constructs a learning model in the configuration in which n=2 is set.

As illustrated in FIG. 8, in step S21, the learning model reading unit 353 reads teacher data stored in the teacher data storage unit 32. In addition, the learning model reading unit 353 reads a learning model from the learning model storage unit 33.

In step S22-21, the learning unit 354-1 constructs the first learning model by using the first loss function on the basis of the teacher data in which the learning image obtained by imaging the surface of the concrete and of which the true value y_{true, i} of the scale is known is associated with the true value y_{true, i} of the scale of the learning image.

In step S23-21, the verification unit 355-1 calculates, for the optimal verification image of which the true value y_{true, i} of the scale is known and that is different from the learning image, a first estimated value y_{pred, i} of the scale by using the first learning model.

In step S24-21, the correlation calculation unit 356-1 calculates a correlation of the first estimated value y_{pred, i} of the scale with respect to the true value y_{true, i} of the scale for the optimal verification image.

In addition, at the same timing as the processing in step S22-21, in step S22-22, the learning unit 354-2 constructs the second learning model by using the second loss function on the basis of the teacher data in which the learning image obtained by imaging the surface of the concrete and of which the true value y_{true, i} of the scale is known is associated with the true value y_{true, i} of the scale of the learning image.

In step S23-22, the verification unit 355-2 calculates, for the optimal verification image of which the true value y_{true, i} of the scale is known and that is different from the learning image, a second estimated value y_{pred, i} of the scale by using the second learning model.

In step S24-22, the correlation calculation unit 356-2 calculates a correlation of the second estimated value y_{pred, i} of the scale with respect to the true value y_{true, i} of the scale for the optimal verification image.

In step S25, the optimal learning model selection unit 357 selects an optimal learning model that is a learning model having the highest correlation among the plurality of learning models.

### (Calculation of Estimated Value of Scale)

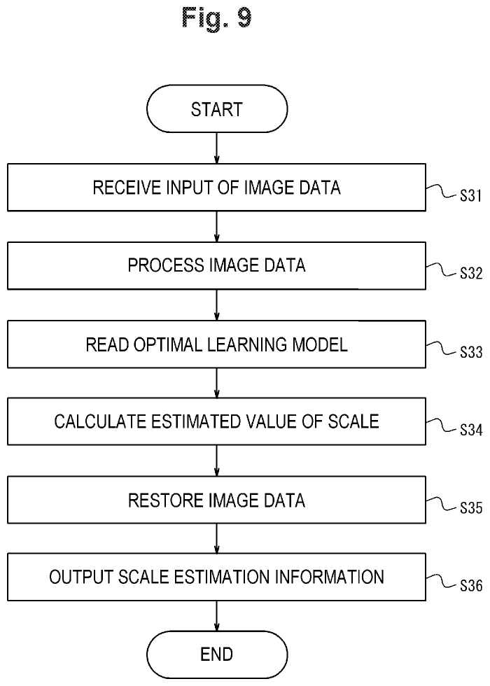

With reference to FIG. 9, a description will be given of a method in which the estimation device 3 calculates an estimated value y_{pred, i} of a scale of an image.

In step S31, the input unit 31 receives input of image data indicating an unknown image of which the scale is unknown output from the data storage device 2.

In step S32, the data processing unit 361 processes the image data indicating the unknown image.

In step S33, the learning model reading unit 362 reads the optimal learning model selected by the optimal learning model selection unit 357.

In step S34, the estimation unit 363 calculates an estimated value y_{pred, i} of the scale of the unknown image of which the true value y_{true, i} of the scale is unknown by using the optimal learning model read by the learning model reading unit 362.

In step S35, the data restoration unit 364 restores the image data indicating the unknown image processed by the data processing unit 361.

In step S36, the output unit 37 outputs scale estimation information including the image data restored in step S35 and the estimated value y_{pred, i} of the scale of the image indicated by the image data calculated in step S34.

Note that, in the estimation system 100A, a method in which the learning model construction device 3A stores teacher data and a method in which the learning model construction device 3A constructs a learning model are the same as the method in which the estimation device 3 stores teacher data and the method in which the estimation device 3 constructs a learning model, respectively. In addition, a method in which the estimation device 3B calculates an estimated value y_{pred, i} of the scale is the same as the method in which the estimation device 3 calculates an estimated value y_{pred, i} of the scale.

As described above, according to the first embodiment, the plurality of learning units 354-k constructs a plurality of learning models by using a respective plurality of loss functions different from each other on the basis of the teacher data in which the learning image obtained by imaging the surface of the concrete and of which the true value y_{true, i} of the scale is known is associated with the true value y_{true, i} of the scale of the learning image. In addition, the verification units 355-k respectively calculate, for the optimal verification image of which the true value y_{true, i} of the scale is known and that is different from the learning image, the estimated values y_{pred, i} of the scale by using the respective plurality of learning models. In addition, the correlation calculation unit 356-k calculates respective correlations of the plurality of estimated values y_{pred, i} of the scale with respect to the true value y_{true, i} of the scale for the optimal verification image. In addition, the optimal learning model selection unit 357 selects an optimal learning model that is a learning model having the highest correlation among the plurality of learning models. As a result, the estimation device 3 and the learning model construction device 3A can construct a learning model with which a scale (calculating an estimated value y_{pred, i} of a scale) of a surface of a concrete structure can be estimated with high accuracy.

In particular, an image obtained by imaging a surface of a concrete structure disposed in a dark place indoors, such as a communication tunnel, includes a lot of noise. For that reason, for example, in a case where only one loss function is used, it may be difficult to construct a learning model in consideration of noise to be an outlier. On the other hand, with use of a plurality of loss functions as in the estimation device 3 of the present embodiment, a learning model is also constructed by another loss function that is greatly affected by the outlier that is hardly considered by one loss function. Therefore, the estimation device 3 of the present embodiment selects an optimal learning model having the highest correlation with the true value y_{true, i} among learning models constructed by using such a plurality of loss functions, thereby being able to estimate the scale with high accuracy in consideration of the outlier.

In addition, according to the first embodiment, the plurality of learning units 354-k constructs a respective plurality of learning models. The plurality of learning units 354-k calculates, for a learning verification image of which a true value y_{true, i} of a scale is known and that is different from the learning image and the optimal verification image, estimated values y_{pred, i} of the scale by using the respective plurality of learning models. The plurality of learning units 354-k constructs the learning models on the basis of loss values L calculated by the loss functions by using the plurality of estimated values y_{pred, i} of the scale for the learning verification image and the true value y_{true, i} of the scale for the learning verification image. As a result, the estimation device 3 and the learning model construction device 3A can construct a learning model with which the scale of the surface of the concrete structure can be estimated with higher accuracy.

In addition, according to the first embodiment, the learning model storage unit 33 stores the optimal learning model selected by the optimal learning model selection unit 357. The estimation unit 363 calculates an estimated value of a scale of an unknown image of which the true value of the scale is unknown by using the optimal learning model. As a result, the estimation device 3 and the estimation device 3A can estimate the scale of the surface of the concrete structure with high accuracy.

In addition, according to the first embodiment, as described with reference to FIG. 7, the estimation device 3 may construct the first learning model, calculate the first estimated value y_{pred, i}, and calculate the correlation of the first estimated value y_{pred, i} with respect to the true value y_{true, i} of the scale, and then construct the second learning model, calculate the second estimated value y_{pred, i}, and calculate the correlation of the second estimated value y_{pred, i} with respect to the true value y_{true, i} of the scale. In addition, in a configuration in which n≥3 is set, the estimation device 3 may repeat construction of a learning model, calculation of an estimated value y_{pred, i}, and calculation of a correlation in the same order. As a result, the estimation device 3 only needs to include one processor without including a plurality of processors, and can have a simple configuration. For the same reason, the learning model construction device 3A can also have a simple configuration.

In addition, according to the first embodiment, as described with reference to FIG. 8, the estimation device 3 may construct the first learning model, calculate the first estimated value y_{pred, i}, and calculate the correlation of the first estimated value y_{pred, i} with respect to the true value y_{true, i} of the scale, and further, at the same timing, construct the second learning model, calculate the second estimated value y_{pred, i}, and calculate the correlation of the second estimated value y_{pred, i} with respect to the true value y_{true, i} of the scale. In addition, in the configuration of n≥3 is set, the estimation device 3 may execute construction of a learning model, calculation of an estimated value y_{pred, i}, and calculation of a correlation, based on each of n loss functions at the same timing. As a result, the estimation device 3 can shorten calculation time as compared with the example described with reference to FIG. 7. For the same reason, the learning model construction device 3A can also shorten calculation time.

### Second Embodiment

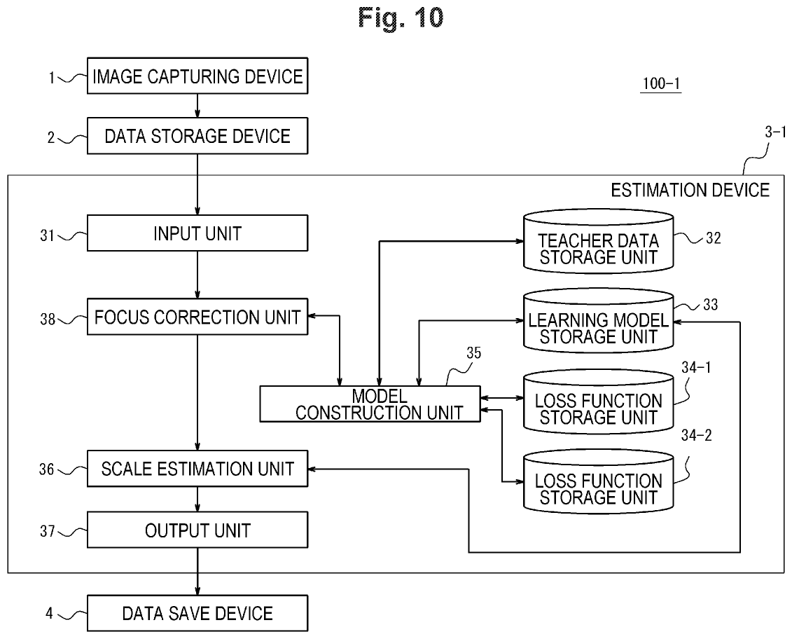

An overall configuration of a second embodiment will be described with reference to FIG. 10. In the second embodiment, the same functional units as those in the first embodiment are denoted by the same reference numerals, and explanation thereof will not be repeated.

As illustrated in FIG. 10, an estimation system 100-1 according to the second embodiment includes the image capturing device 1, the data storage device 2, an estimation device 3-1, and the data save device 4.

### <Configuration of Estimation Device>

The estimation device 3-1 includes the input unit 31, the teacher data storage unit 32, the learning model storage unit 33, the loss function storage units 34-k, the model construction unit 35, the scale estimation unit 36, the output unit 37, and a focus correction unit 38. The focus correction unit 38 includes a controller.

The focus correction unit 38 corrects image data indicating an image including a learning image and an optimal verification image to cause an out-of-focus portion not to be included in the image. The focus correction unit 38 may correct the image further including an unknown image to cause an out-of-focus portion not to be included in the image. The focus correction unit 38 may correct the image further including a learning verification image to cause an out-of-focus portion not to be included in the image.

Specifically, the focus correction unit 38 determines whether or not an image indicated by image data of which the input unit 31 receives input includes an out-of-focus portion that is a portion out of focus. For example, the focus correction unit 38 may determine whether or not there is an out-of-focus portion in the image by using a fast Fourier transform (FFT), an image processing method such as edge detection using Laplacian differentiation, a deep learning method, or the like.

In addition, when determining that there is an out-of-focus portion in the image, the focus correction unit 38 corrects the image to cause the out-of-focus portion not to be included. For example, the focus correction unit 38 may remove the out-of-focus portion from the image, or may convert the out-of-focus portion to cause the out-of-focus portion to be not out of focus. In addition, in the conversion, the focus correction unit 38 may execute sharpening processing using an unsharp mask or the like.

The model construction unit 35 executes processing similar to that of the first embodiment by using the image corrected by the focus correction unit 38.

The scale estimation unit 36 executes processing similar to that of the first embodiment by using the image corrected by the focus correction unit 38.

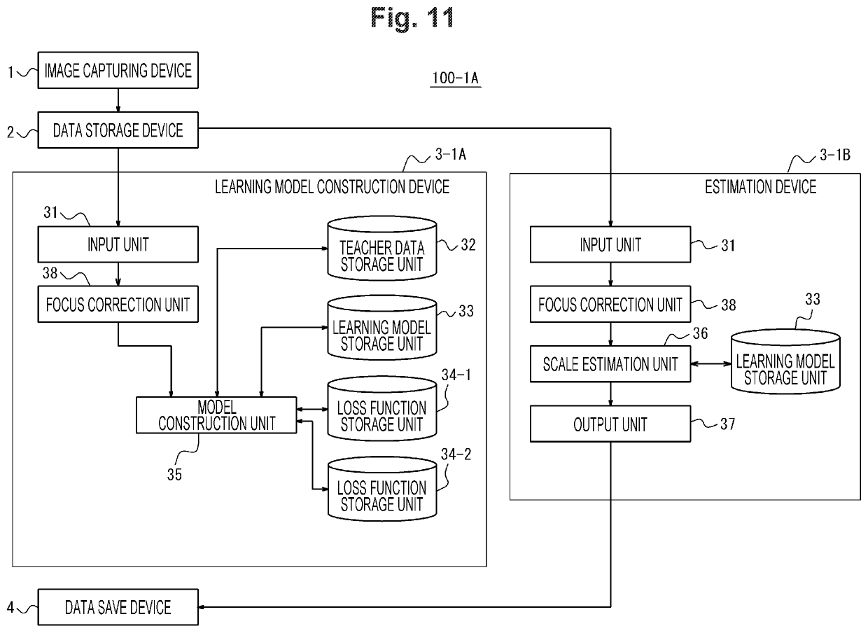

As illustrated in FIG. 11, an estimation system 100-1A of another example of the second embodiment includes the image capturing device 1, the data storage device 2, a learning model construction device 3-1A, an estimation device 3-1B, and the data save device 4. In the estimation system 100-1A, the learning model construction device 3-1A includes the input unit 31, the teacher data storage unit 32, the learning model storage unit 33, the loss function storage units 34-k, the model construction unit 35, and the focus correction unit 38. In addition, the estimation device 3-1B includes the input unit 31, the learning model storage unit 33, the scale estimation unit 36, the output unit 37, and the focus correction unit 38. Note that, in the estimation system 100-1A, functional units denoted by the same reference numerals as those of the estimation system 100-1 have the same functions. However, in the estimation system 100-1A, the focus correction unit 38 of the learning model construction device 3-1A corrects the learning image, the optimal verification image, and the learning verification image, and the focus correction unit 38 of the estimation device 3-1B corrects the unknown image.

### <Operation of Estimation Device>

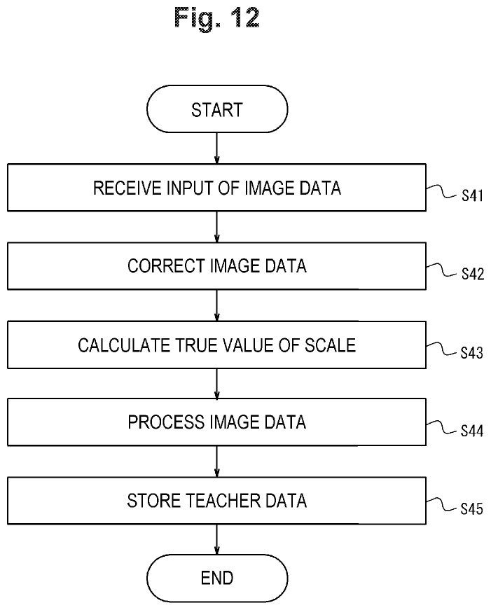

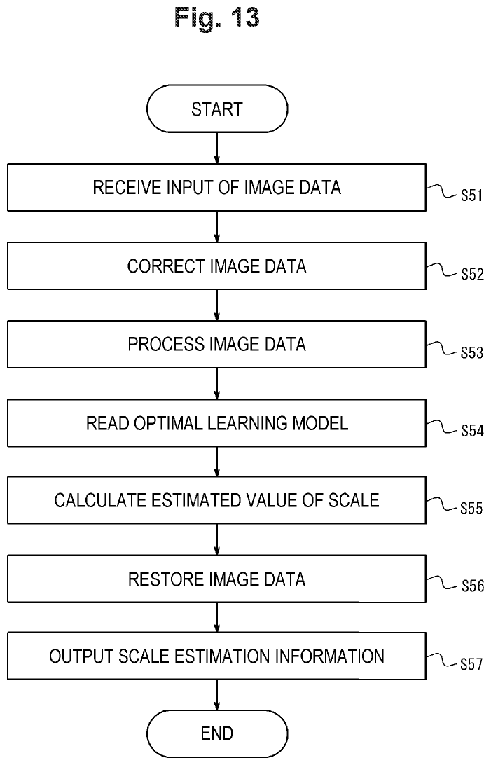

Here, operation of the estimation device 3-1 according to the second embodiment will be described with reference to FIGS. 12 and 13. FIGS. 12 and 13 are flowcharts illustrating an example of the operation of the estimation device 3-1 according to the second embodiment. The operation of the estimation device 3-1 described with reference to FIGS. 12 and 13 corresponds to an example of an estimation method executed by the estimation device 3-1 according to the second embodiment.

### (Storage of Teacher Data)

With reference to FIG. 12, a description will be given of a method in which the estimation device 3-1 stores teacher data.

The estimation device 3-1 executes the processing in step S41. The processing in step S41 is the same as the processing in step S11 in the first embodiment.

In step S42, the focus correction unit 38 corrects an image including a learning image and an optimal verification image to cause an out-of-focus portion not to be included in the image.

In step S43, the scale calculation unit 351 calculates a true value y_{true, i} of a scale of the image corrected by the focus correction unit 38.

Subsequently, the estimation device 3-1 executes the processing in steps S44 and S45. The processing in step S45 and up to S46 is the same as the processing in steps S13 and S14 in the first embodiment.

### (Construction of Learning Model)

A description will be given of a method in which the estimation device 3-1 constructs a learning model.

The method in which the estimation device 3-1 constructs a learning model is the same as the method in which the estimation device 3 constructs a learning model in the first embodiment.

### (Calculation of Estimated Value of Scale)

With reference to FIG. 13, a description will be given of a method in which the estimation device 3-1 calculates an estimated value y_{pred, i} of a scale of an image.

The estimation device 3-1 executes the processing in step S51. The processing in step S51 is the same as the processing in step S31 in the first embodiment.

In step S52, the focus correction unit 38 corrects an unknown image to cause an out-of-focus portion not to be included in the image.

In step S53, the data processing unit 352 processes the image data indicating the image corrected in step S52.

Subsequently, the estimation device 3-1 executes processing from step S54 to step S57. The processing from step S54 to step S57 is the same as the processing from step S33 to step S36 in the first embodiment.

Note that a method in which the learning model construction device 3-1A stores teacher data and a method in which the learning model construction device 3-1A constructs a learning model are the same as the method in which the estimation device 3-1 stores teacher data and the method in which the estimation device 3-1 constructs a learning model, respectively. In addition, a method in which the estimation device 3-1B calculates an estimated value y_{pred, i} of the scale is the same as the method in which the estimation device 3-1 calculates an estimated value y_{pred, i} of the scale.

As described above, according to the second embodiment, the estimation device 3-1 and the learning model construction device 3-1A correct an image including a learning image and an optimal verification image to cause an out-of-focus portion not to be included in the image. As a result, the estimation device 3-1 and the learning model construction device 3-1A can suppress a decrease in the accuracy of the learning model due to out of focus of an image indicating a void, a shadow, or the like formed on a surface of concrete such as a communication tunnel. In addition, the estimation device 3-1 and the estimation device 3-1B can also estimate a scale of an out-of-focus image with high accuracy.

### Third Embodiment

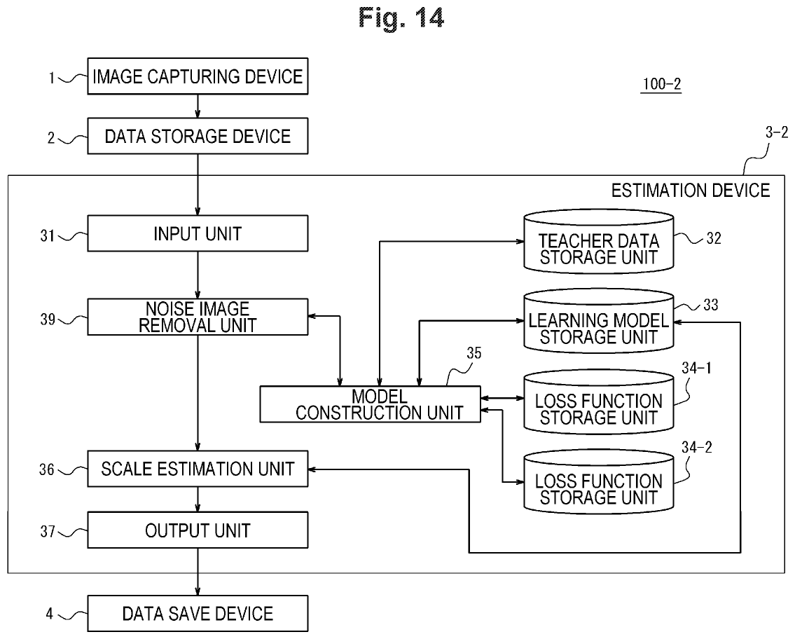

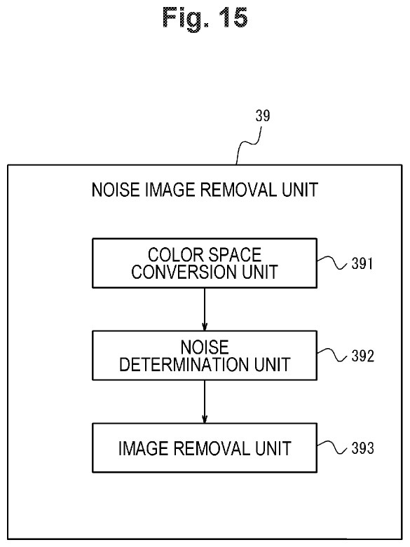

An overall configuration of a third embodiment will be described with reference to FIGS. 14 and 15. In the third embodiment, the same functional units as those in the first embodiment are denoted by the same reference numerals, and explanation thereof will not be repeated.

As illustrated in FIG. 14, an estimation system 100-2 according to the third embodiment includes the image capturing device 1, the data storage device 2, an estimation device 3-2, and the data save device 4.

### <Configuration of Estimation Device>

The estimation device 3-2 includes the input unit 31, the teacher data storage unit 32, the learning model storage unit 33, the loss function storage units 34-k, the model construction unit 35, the scale estimation unit 36, the output unit 37, and a noise image removal unit 39. The noise image removal unit 39 includes a controller.

As illustrated in FIG. 15, the noise image removal unit 39 includes a color space conversion unit 391, a noise determination unit 392, and an image removal unit 393.

The color space conversion unit 391 converts a color space of an image indicated by image data of which the input unit 31 receives input. For example, in a case where the color space of the image indicated by the image data of which the input unit 31 receives input is an RGB color space, the color space conversion unit 391 converts the color space of the image from the RGB color space into an L*a*b* color space. An L* component in the L*a*b* color space is a component representing brightness, and an a* (green-red) component and a b* (blue-yellow) component are chromaticity components. As described above, the color space conversion unit 391 can clearly distinguish and represent a color of color noise and a color of concrete by setting a color space of an image obtained by imaging a concrete structure as a subject as the L*a*b* color space. For the same reason, the color space conversion unit 391 may convert the color space of the image into an Luv color space.

On the basis of a chromaticity component in the color space of an image including a learning image and an optimal verification image, the noise determination unit 392 determines whether or not color noise is included in the image. On the basis of a chromaticity component in the color space of the image further including a learning verification image, the noise determination unit 392 may determine whether or not color noise is included in the image. On the basis of a chromaticity component in the color space of the image further including an unknown image, the noise determination unit 392 may determine whether or not color noise is included in the image. For example, in a case where the color space conversion unit 391 converts the color space of the image into the L*a*b* color space, the noise determination unit 392 determines whether or not color noise is included in the image on the basis of a pixel value of an a* component or a b* component that is a color component in the L*a*b* color space.

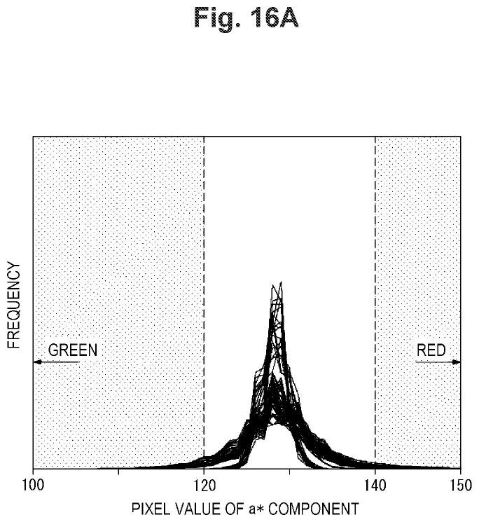

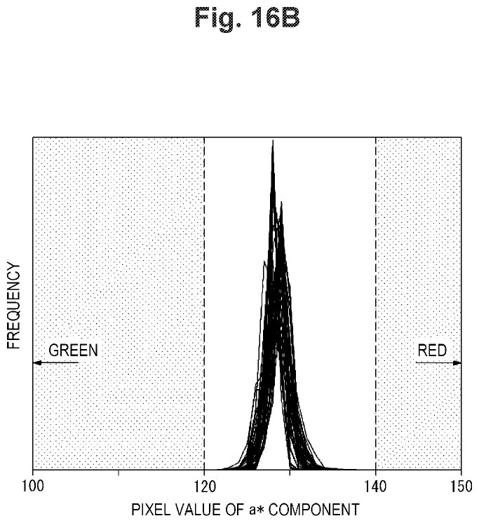

In a case where color noise occurs in the image, as illustrated in FIG. 16A, pixel values of the a* component are distributed in a range less than a first threshold (120 in the present example) and a range greater than a second threshold (140 in the present example) greater than the first threshold. On the other hand, in a case where no color noise occurs in the image, as illustrated in FIG. 16B, the pixel values of the a* component are hardly distributed in the range less than the first threshold and the range greater than the second threshold. For this reason, the noise determination unit 392 can determine whether or not color noise occurs in the image on the basis of the pixel values of the a component of pixels constituting the image and the first threshold and the second threshold.

Thus, as a first example, in a case where a pixel value of the a component of any pixel constituting the image is in a range less than the first threshold or greater than the second threshold (in a case where Formula (5) is not satisfied), the noise determination unit 392 determines that color noise occurs in the image. In addition, in a case where the pixel values of the a* component of all the pixels constituting the image are in a range of greater than or equal to the first threshold and less than or equal to the second threshold (in a case where Formula (5) is satisfied), the noise determination unit 392 determines that no color noise occurs in the image. Note that a*_{i, j} is a pixel value of the a* component of a pixel located at coordinates (i, j) in the image, i is an x coordinate of the pixel, and j is a y coordinate of the pixel.

$$\begin{matrix}[ Math . 5 ] & \\ 120 \leq a {*}_{i , j} ⋂ a {*}_{i , j} \leq 140 & ( 5 )\end{matrix}$$

As a second example, the noise determination unit 392 may determine noise on the basis of whether or not variance of pixel values of the a* component in the image is greater than a third threshold β, as shown in Formula (6). Specifically, in a case where the variance of the pixel values of the a* component in the image is greater than the third threshold β (in a case where Formula (6) is satisfied), the noise determination unit 392 determines that color noise occurs in the image. In a case where the variance of the pixel values of the a* component in the image is less than or equal to the third threshold β (in a case where Formula (6) is not satisfied), the noise determination unit 392 determines that no color noise occurs in the image. Note that a*ₐᵥₑ may be an average value of the a* component in a plurality of pixels constituting a plurality of images, or may be an average value of the a* component in a plurality of pixels constituting one image.

$$\begin{matrix}[ Math . 6 ] & \\ {( a {*}_{i , j} - a {*}_{ave} )}^{2} > β & ( 6 )\end{matrix}$$

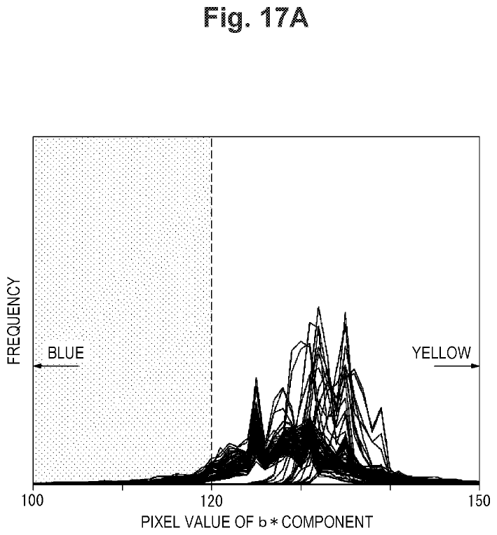

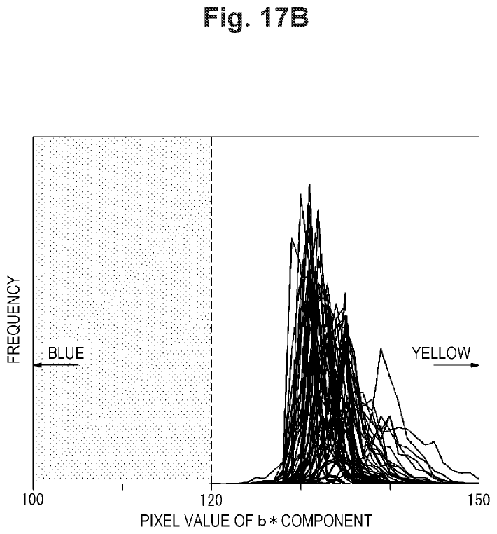

In addition, in a case where color noise occurs in the image, as illustrated in FIG. 17A, pixel values of the b* component are distributed also in a range less than a fourth threshold (120 in the present example). On the other hand, in a case where no color noise occurs in the image, as illustrated in FIG. 17B, the pixel values of the b* component are hardly distributed in the range less than the fourth threshold. For this reason, the noise determination unit 392 can determine noise in the image on the basis of the pixel values of the b* component of pixels constituting the image and the fourth threshold.

Thus, as a third example, in a case where a pixel value of the b* component of any pixel constituting the image is less than the fourth threshold (in a case where Formula (7) is not satisfied), the noise determination unit 392 determines that color noise occurs in the image. In addition, in a case where pixel values of the b* component of all the pixels constituting the image are greater than or equal to the fourth threshold (in a case where Formula (7) is satisfied), the noise determination unit 392 determines that no color noise occurs in the image. Note that b*_{i, j} is a pixel value of the b* component at the coordinates (i, j) of the image.

$$\begin{matrix}[ Math . 7 ] & \\ b {*}_{i , j} \geq 120 & ( 7 )\end{matrix}$$

In addition, the noise determination unit 392 may determine noise by using any two or more methods described in the first to third examples described above.

The image removal unit 393 removes, from a set of image data, image data indicating an image for which it is determined by the noise determination unit 392 that color noise occurs. For example, the image removal unit 393 may delete the image data indicating the image for which it is determined that color noise occurs. In addition, the image removal unit 393 may move the image data indicating the image for which it is determined that color noise occurs to a folder (logical area in a memory) different from a folder storing a plurality of image data.

The model construction unit 35 executes processing similar to that of the first embodiment by using an image not removed by the noise image removal unit 39.

For example, the learning units 354-k construct learning models on the basis of teacher data in which image data indicating a learning image determined not to include color noise is associated with a true value of a scale of the learning image, similarly to the first embodiment. In addition, the verification units 355-k calculate estimated values y_{pred, i} of the scale for an optimal verification image determined not to include color noise, similarly to the first embodiment.

In addition, the scale estimation unit 36 executes processing similar to that of the first embodiment by using the image not removed by the noise image removal unit 39.

For example, the scale estimation unit 36 calculates an estimated value y_{pred, i} of the scale for an unknown image determined not to include color noise, similarly to the first embodiment.

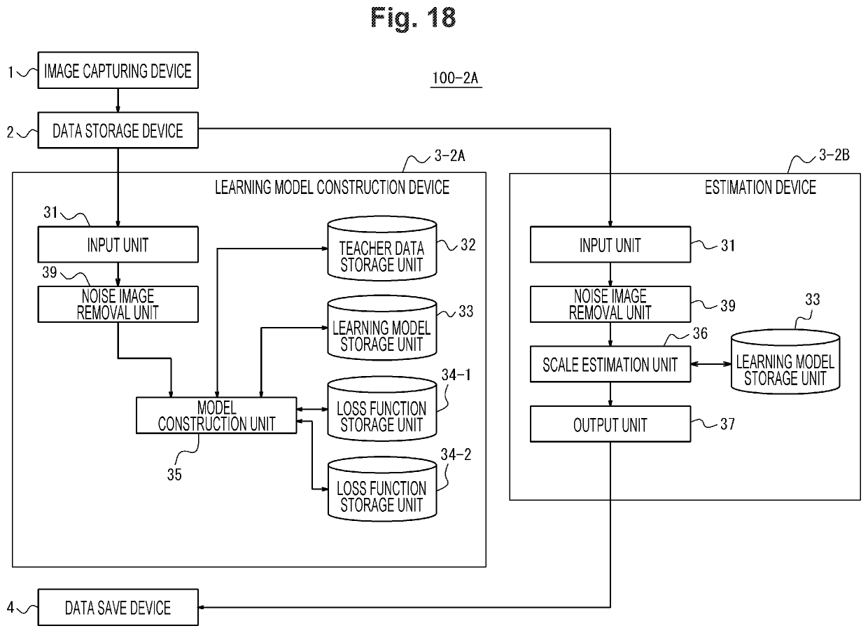

As illustrated in FIG. 18, an estimation system 100-2A of another example of the third embodiment includes the image capturing device 1, the data storage device 2, a learning model construction device 3-2A, an estimation device 3-2B, and the data save device 4. The learning model construction device 3-2A includes the input unit 31, the teacher data storage unit 32, the learning model storage unit 33, the loss function storage units 34-k, the model construction unit 35, and the noise image removal unit 39. In addition, the estimation device 3-2B includes the input unit 31, the learning model storage unit 33, the scale estimation unit 36, the output unit 37, and the noise image removal unit 39. Note that, in the estimation system 100-2A, functional units denoted by the same reference numerals as those of the estimation system 100-2 have the same functions. However, in the estimation system 100-2A, the noise determination unit 392 of the learning model construction device 3-2A determines whether or not color noise is included in the learning image, the optimal verification image, and the learning verification image, and the noise determination unit 392 of the estimation device 3-2B determines whether or not color noise is included in the unknown image.

### <Operation of Estimation Device>

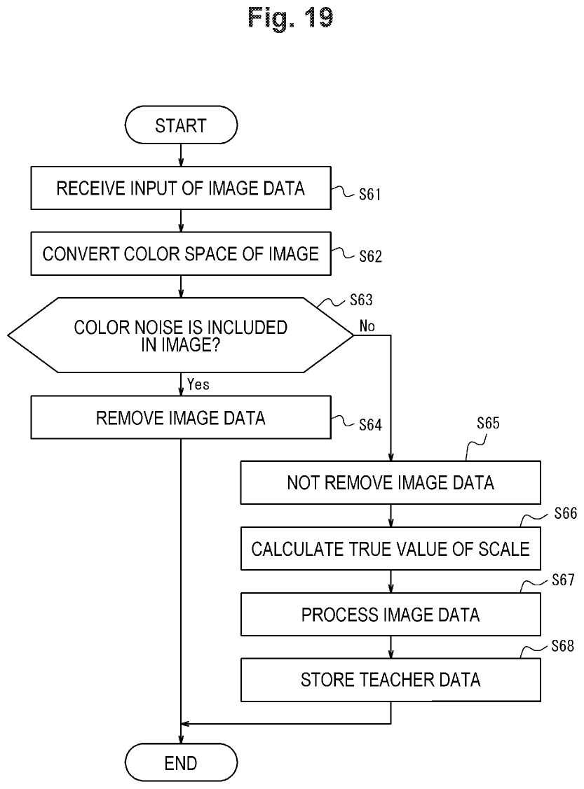

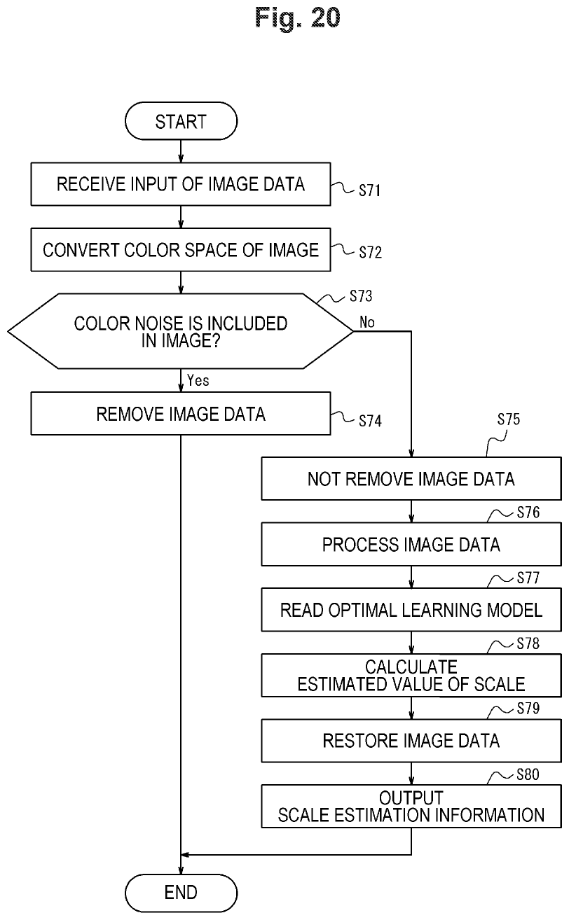

Here, operation of the estimation device 3-2 according to the third embodiment will be described with reference to FIGS. 19 and 20. FIGS. 19 and 20 are flowchart illustrating an example of the operation of the estimation device 3-2 according to the third embodiment. The operation of the estimation device 3-2 described with reference to FIGS. 19 and 20 corresponds to an example of an estimation method executed by the estimation device 3-2 according to the third embodiment.

### (Storage of Teacher Data)

With reference to FIG. 19, a description will be given of a method in which the estimation device 3-2 stores teacher data.

The estimation device 3-2 executes the processing in step S61. The processing in step S61 is the same as the processing in step S11 in the first embodiment.

In step S62, the color space conversion unit 391 converts the color space of the image of which the input unit 31 receives input.

In step S63, on the basis of a chromaticity component in the color space of an image including a learning image, an optimal verification image, and an unknown image, the noise determination unit 392 determines whether or not color noise is included in the image.

When it is determined in step S63 that color noise is included, the image removal unit 393 removes the image data from a set of a plurality of image data in step S64.

When it is determined in step S63 that color noise is not included, the image removal unit 393 does not remove the image data from the set of the plurality of image data in step S65.

When step S65 is executed, the estimation device 3-2 executes the processing from step S66 to step S68. The processing from step S66 to step S68 is the same as the processing from step S12 to step S14 in the first embodiment.

When the processing in step S64 or step S68 is executed, the estimation device 3-2 ends the processing of storing the teacher data.

### (Construction of Learning Model)

A description will be given of a method in which the estimation device 3-2 constructs a learning model.

The method in which the estimation device 3-2 constructs a learning model is the same as the method in which the estimation device 3 constructs a learning model in the first embodiment.

### (Estimation of Scale)

With reference to FIG. 20, a description will be given of a method in which the estimation device 3-2 calculates an estimated value y_{pred, i} of a scale of an image.

The estimation device 3-2 executes the processing from step S71 to step S75. The processing from step S71 to step S75 is the same as the processing from step S61 to step S65 in the method in which the estimation device 3-2 stores teacher data. However, in step S71, the image data of which the input unit 31 receives input is image data indicating an unknown image of which the true value y_{true, i} of the scale is unknown.

When the image data is removed in step S74, the estimation device 3-2 ends the processing of calculating the estimated value y_{pred, i} of the scale.

When the image data is not removed in step S75, the estimation device 3-2 executes processing from step S76 to step S80. The processing from step S76 to step S80 is the same as the processing from step S32 to S36 in the first embodiment.

Note that a method in which the learning model construction device 3-2A stores teacher data and a method in which the learning model construction device 3-2A constructs a learning model are the same as the method in which the estimation device 3-2 stores teacher data and the method in which the estimation device 3-2 constructs a learning model, respectively. In addition, a method in which the estimation device 3-2B calculates an estimated value y_{pred, i} of the scale is the same as the method in which the estimation device 3-2 calculates an estimated value y_{pred, i} of the scale.

As described above, according to the third embodiment, on the basis of a chromaticity component in the color space of an image including a learning image, an optimal verification image, and an unknown image, the estimation device 3-2 and the learning model construction device 3-2A determine whether or not color noise is included in the image. The estimation device 3-2 and the learning model construction device 3-2A construct a learning model on the basis of teacher data in which the learning image determined not to include color noise is associated with the true value y_{true, i} of the scale of the learning image. In addition, the estimation device 3-2 and the estimation device 3-2B calculate an estimated value y_{pred, i} of the scale for an unknown image determined not to include color noise.

In imaging a surface of a concrete structure disposed indoors, a shutter speed of the camera is adjusted to a low speed so that the camera can receive more light. As a result, color noise (false color) that is a color that the subject in the real space does not have, such as red, blue, and green, may occur in pixels constituting an image obtained by imaging the indoor concrete structure by the camera. Accordingly, in the image, a feature of texture formed on the surface of the concrete structure may be lost or divided. Thus, the accuracy in estimating the scale of the image obtained by imaging the surface may be decreased.

It is known to use a median filter to suppress such color noise. With use of the median filter, a pixel value of a pixel expected to have color noise is converted on the basis of a relationship between a central pixel in an image and a neighboring pixel located in the vicinity of the central pixel. At this time, there is a possibility that pixel values of pixels indicating unevenness, shadow, and the like formed on the surface of the concrete structure included in the image are converted. For this reason, the scale of the image may not be estimated with high accuracy even by using the median filter.

On the other hand, the estimation device 3-2 and the learning model construction device 3-2A according to the third embodiment can suppress a decrease in the accuracy of the learning model due to the use of an image including color noise. That is, the estimation device 3-2 and the learning model construction device 3-2A do not use the image including color noise, thereby being able to construct a learning model with which the estimated value y_{pred, i} of the scale can be calculated with high accuracy. In addition, in the processing of calculating the estimated value y_{pred, i} of the scale, the estimation device 3-2 and the estimation device 3-2B remove the image including color noise, thereby being able to suppress that the scale is estimated with low accuracy.

### <First Modification>

Note that, in the first embodiment described above, the estimation device 3 and the learning model construction device 3A do not have to include the scale calculation unit 351. In such a configuration, the estimation device 3 and the learning model construction device 3A may receive input of a true value y_{true, i} of a scale of an image indicated by image data together with the image data by the input unit 31. As a result, the estimation device 3 and the learning model construction device 3A do not need to calculate the true value y_{true, i} of the scale of the image, and can suppress a processing load. Note that the estimation device 3 and the learning model construction device 3A do not execute step S12 in the processing of storing the teacher data described above in the configuration in which the scale calculation unit 351 is not included.

In addition, the estimation device 3-1 and the learning model construction device 3-1A of the second embodiment, and the estimation device 3-2 and the learning model construction device 3-2A of the third embodiment do not have to include the scale calculation unit 351 similarly. In addition, in such a configuration, in the estimation device 3-1, the learning model construction device 3-1A, the estimation device 3-2, and the learning model construction device 3-2A, step S43 and step S66 in the processing of storing the teacher data are not executed.

### <Second Modification>

In addition, in the first embodiment described above, the estimation device 3 and the learning model construction device 3A do not have to include the data processing unit 352, the data processing unit 361, or the data restoration unit 364. In such a configuration, as described above, the teacher data storage unit 32 may store teacher data in which unprocessed image data is associated with the true value y_{true, i} of the scale of an image indicated by the image data. Note that, in the configuration in which the data processing unit 352, the data processing unit 361, and the data restoration unit 364 are not included, the estimation device 3 and the learning model construction device 3A do not execute step S13 in the processing of storing the teacher data described above. In addition, the estimation device 3 and the learning model construction device 3A do not execute step S32 or step S35 in the processing of calculating the estimated value y_{pred, i} of the scale described above.

In addition, the estimation device 3-1 and the learning model construction device 3-1A of the second embodiment, and the estimation device 3-2 and the learning model construction device 3-2A of the third embodiment do not have to include the data processing unit 352, the data processing unit 361, or the data restoration unit 364 similarly. In addition, in such a configuration, in the estimation device 3-1 and the learning model construction device 3-1A, and the estimation device 3-2 and the learning model construction device 3-2A, step S44 and step S67 in the processing of storing the teacher data are not executed. In the estimation device 3-1 and the estimation device 3-2, step S44 and step S67 in the processing of storing the teacher data are not executed. In addition, in the estimation device 3-1, the learning model construction device 3-1A, the estimation device 3-2, and the learning model construction device 3-2A, steps S53, S56, S76, and S79 are not executed in the processing of calculating the estimated value y_{pred, i} of the scale described above.

### <Program>

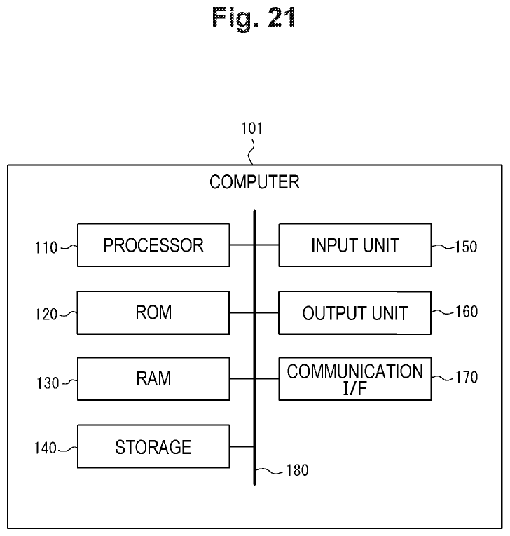

The estimation devices 3, 3-1, and 3-2 described above can be implemented by a computer 101. In addition, a program by which the estimation devices 3, 3-1, and 3-2 functions may be provided. In addition, the program may be stored in a storage medium or may be provided through a network. FIG. 21 is a block diagram illustrating a schematic configuration of the computer 101 that functions as each of the estimation devices 3, 3-1, and 3-2. Here, the computer 101 may be a general-purpose computer, a dedicated computer, a workstation, a personal computer (PC), an electronic notepad, or the like. A program instruction may be a program code, a code segment, or the like for executing a required task. The same applies to the learning model construction devices 3A, 3-1A, and 3-2A and the estimation devices 3B, 3-1B, and 3-2B.

As illustrated in FIG. 21, the computer 101 includes a processor 110, a read only memory (ROM) 120, a random access memory (RAM) 130, a storage 140, an input unit 150, an output unit 160, and a communication interface (I/F) 170. The components are communicably connected to one another via a bus 180. Specifically, the processor 110 is a central processing unit (CPU), a micro processing unit (MPU), a graphics processing unit (GPU), a digital signal processor (DSP), a system on a chip (SoC), or the like, and may include a plurality of processors of the same or different types.

The processor 110 executes control on the components and various types of arithmetic processing. That is, the processor 110 reads a program from the ROM 120 or the storage 140 and executes the program by using the RAM 130 as a working area. The processor 110 performs control of the components described above and various types of arithmetic processing in accordance with a program stored in the ROM 120 or the storage 140. In the embodiments described above, a program according to the present disclosure is stored in the ROM 120 or the storage 140.

The program may be stored in a storage medium that can be read by the computer 101. Using such a storage medium makes it possible to install the program in the computer 101. Here, the storage medium in which the program is stored may be a non-transitory storage medium. The non-transitory storage medium is not limited to any particular kind, but may be a CD-ROM, a DVD-ROM, a universal serial bus (USB) memory, or the like, for example. In addition, the program may be downloaded from an external device via a network.

The ROM 120 stores various programs and various types of data. The RAM 130 temporarily stores a program or data as a working area. The storage 140 includes a hard disk drive (HDD) or a solid state drive (SSD), and stores various programs including an operating system and various types of data.

The input unit 150 includes one or more input interfaces that receive a user's input operation and acquire information based on the user's operation. For example, the input unit 150 is a pointing device, a keyboard, a mouse, or the like, but is not limited to these.

The output unit 160 includes one or more output interfaces that output information. For example, the output unit 160 is a display that outputs information as a video image or a speaker that outputs information as sound, but is not limited to these. Note that, in a case where the output unit 160 is a touch panel display, the output unit 160 also functions as the input unit 150.

The communication interface (I/F) 170 is an interface for communicating with an external device.

With regard to the above embodiments, the following supplementary notes are further disclosed.

### (Supplement 1)

A learning model construction device including:
a memory; and
at least one controller connected to the memory, in which
the controller:
constructs a respective plurality of learning models by using a respective plurality of loss functions different from each other on the basis of teacher data in which image data indicating a learning image obtained by imaging a surface of concrete and of which a true value of a scale is known is associated with the true value of the scale of the learning image;
calculates, for an optimal verification image of which a true value of a scale is known and that is different from the learning image, a respective plurality of estimated values of the scale by using the respective plurality of learning models;
calculates, for the optimal verification image, respective correlations of the plurality of estimated values of the scale with the true value of the scale; and
selects an optimal learning model that is a learning model of which a corresponding one of the correlations is the highest among the plurality of learning models.

### (Supplement 2)

The learning model construction device according to supplement 1, in which each of the controllers performs learning of the plurality of learning models, calculates, for a learning verification image of which a true value of a scale is known and that is different from the learning image and the optimal verification image, estimated values of the scale by using the respective plurality of learning models, and constructs the learning models on the basis of loss values calculated by the loss functions by using the plurality of estimated values for the learning verification image and the true value of the scale for the learning verification image.

### (Supplement 3)

The learning model construction device according to supplement 1 or 2, in which the controller corrects an image including the learning image and the optimal verification image to cause an out-of-focus portion that is a portion out of focus not to be included in the image.

### (Supplement 4)

The learning model construction device according to any one of supplements 1 to 3, in which
the controller
determines, on the basis of a chromaticity component in a color space of an image including the learning image and the optimal verification image, whether or not color noise is included in the image, and
constructs the learning models on the basis of the teacher data in which image data indicating the learning image determined not to include the color noise is associated with the true value of the scale of the learning image.

### (Supplement 5)

An estimation device including:
a memory that stores the optimal learning model constructed by the learning model construction device according to supplements 1 to 4; and
a controller that calculates an estimated value of a scale of an unknown image of which the true value of the scale is unknown by using the optimal learning model.

### (Supplement 6)

A learning model construction method including:
a step of constructing a respective plurality of learning models by using a respective plurality of loss functions different from each other on the basis of teacher data in which image data indicating a learning image obtained by imaging a surface of concrete and of which a true value of a scale is known is associated with the true value of the scale of the learning image;
a step of calculating, for an optimal verification image of which a true value of a scale is known and that is different from the learning image, a respective plurality of estimated values of the scale by using the respective plurality of learning models;
a step of calculating, for the optimal verification image, respective correlations of the plurality of estimated values of the scale with the true value of the scale; and
a step of selecting an optimal learning model that is a learning model of which a corresponding one of the correlations is the highest among the plurality of learning models.

### (Supplement 7)

An estimation method executed by an estimation device including a memory that stores the optimal learning model selected by the learning model construction method according to supplement 6, the estimation method including
a step of calculating an estimated value of a scale of an unknown image of which the true value of the scale is unknown by using the optimal learning model.

### (Supplement 8)

A non-transitory storage medium storing a program executable by a computer, the non-transitory storage medium storing a program causing the computer to function as the estimation device according to any one of supplements 1 to 4.

All documents, patent applications, and technical standards described in this specification are incorporated herein by reference to the same extent as in a case where incorporation by reference of each document, patent application, and technical standard is specifically and individually described.

Although the above-described embodiments have been described as representative examples, it is apparent to those skilled in the art that many modifications and substitutions can be made within the spirit and scope of the present disclosure. Accordingly, it should not be understood that the present invention is limited by the above embodiments, and various modifications or changes can be made within the scope of the claims. For example, a plurality of configuration blocks illustrated in the configuration diagrams of the embodiments can be combined into one, or one configuration block can be divided.

### REFERENCE SIGNS LIST

1 Image capturing device
2 Data storage device
3, 3-1, 3-2 Estimation device
3A, 3-1A, 3-2A Learning model construction device
3B, 3-1B, 3-2B Estimation device
4 Data save device
31 Input unit
32 Teacher data storage unit
33 Learning model storage unit
34-k Loss function storage unit
35 Model construction unit
36 Scale estimation unit
37 Output unit
38 Focus correction unit
39 Noise image removal unit
100, 100-1, 100-2 Estimation system
100A, 100-1A, 100-2A Estimation system
101 Computer
110 Processor
120 ROM
130 RAM
140 Storage
150 Input unit
160 Output unit
170 Communication interface
180 Bus
351 Scale calculation unit
352 Data processing unit
353 Learning model reading unit
354-k Learning unit
355-k Verification unit
356-k Correlation calculation unit
357 Optimal learning model selection unit
361 Data processing unit
362 Learning model reading unit
363 Estimation unit
364 Data restoration unit
391 Color space conversion unit
392 Noise determination unit
393 Image removal unit

1. A learning model construction device comprising:
a plurality of learning units that constructs a respective plurality of learning models by using a respective plurality of loss functions different from each other on a basis of teacher data in which image data indicating a learning image obtained by imaging a surface of concrete and of which a true value of a scale is known is associated with the true value of the scale of the learning image;
a plurality of verification units that calculates, for an optimal verification image of which a true value of a scale is known and that is different from the learning image, a respective plurality of estimated values of the scale by using the respective plurality of learning models;
a plurality of correlation calculation units that calculates, for the optimal verification image, respective correlations of the plurality of estimated values of the scale with the true value of the scale; and
an optimal learning model selection unit that selects an optimal learning model that is a learning model of which a corresponding one of the correlations is highest among the plurality of learning models.

2. The learning model construction device according to claim 1, wherein the plurality of learning units respectively performs learning of the plurality of learning models, calculates, for a learning verification image of which a true value of a scale is known and that is different from the learning image and the optimal verification image, estimated values of the scale by using the respective plurality of learning models, and constructs the learning models on a basis of loss values calculated by the loss functions by using the plurality of estimated values for the learning verification image and the true value of the scale for the learning verification image.

3. The learning model construction device according to claim 1, further comprising a focus correction unit that corrects an image including the learning image and the optimal verification image to cause an out-of-focus portion that is a portion out of focus not to be included in the image.

4. The learning model construction device according to claim 1, further comprising:
a noise determination unit that determines, on a basis of a chromaticity component in a color space of an image including the learning image and the optimal verification image, whether or not color noise is included in the image, wherein
the learning units construct the learning models on a basis of the teacher data in which image data indicating the learning image determined not to include the color noise is associated with the true value of the scale of the learning image.

5. An estimation device comprising:
a learning model storage unit that stores the optimal learning model selected by the learning model construction device according to claim 1; and
an estimation unit that calculates an estimated value of a scale of an unknown image of which the true value of the scale is unknown by using the optimal learning model.

6. A learning model construction method comprising:
constructing a respective plurality of learning models by using a respective plurality of loss functions different from each other on a basis of teacher data in which image data indicating a learning image obtained by imaging a surface of concrete and of which a true value of a scale is known is associated with the true value of the scale of the learning image;
calculating, for an optimal verification image of which a true value of a scale is known and that is different from the learning image, a respective plurality of estimated values of the scale by using the respective plurality of learning models;
calculating, for the optimal verification image, respective correlations of the plurality of estimated values of the scale with the true value of the scale; and
selecting an optimal learning model that is a learning model of which a corresponding one of the correlations is highest among the plurality of learning models.

7. An estimation method executed by an estimation device including a learning model storage unit that stores the optimal learning model selected by the learning model construction method according to claim 6, the estimation method comprising:
calculating an estimated value of a scale of an unknown image of which the true value of the scale is unknown by using the optimal learning model.

8. (canceled)

9. A computer-readable non-transitory recording medium storing computer-executable program instructions that when executed by a processor cause a computer to execute a program generation method comprising:
construct a respective plurality of learning models by using a respective plurality of loss functions different from each other on a basis of teacher data in which image data indicating a learning image obtained by imaging a surface of concrete and of which a true value of a scale is known is associated with the true value of the scale of the learning image;
calculate, for an optimal verification image of which a true value of a scale is known and that is different from the learning image, a respective plurality of estimated values of the scale by using the respective plurality of learning models;
calculate, for the optimal verification image, respective correlations of the plurality of estimated values of the scale with the true value of the scale; and
select an optimal learning model that is a learning model of which a corresponding one of the correlations is highest among the plurality of learning models.

10. The method according to claim 9, wherein performing, learning of the plurality of learning models, calculating, for a learning verification image of which a true value of a scale is known and that is different from the learning image and the optimal verification image, estimating values of the scale by using the respective plurality of learning models, and constructing the learning models on a basis of loss values calculated by the loss functions by using the plurality of estimated values for the learning verification image and the true value of the scale for the learning verification image.

11. The method according to claim 9 further comprising an image correction including the learning image and the optimal verification image to cause an out-of-focus portion that is a portion out of focus not to be included in the image.

12. The method according to claim 9 further comprising:
determining, on a basis of a chromaticity component in a color space of an image including the learning image and the optimal verification image, whether or not color noise is included in the image, wherein
the learning models are constructed on a basis of the teacher data in which image data indicating the learning image determined not to include the color noise is associated with the true value of the scale of the learning image.

13. The learning model construction device according to claim 1, wherein a data processing unit processes the image data representing an image for which a scale true value has been calculated.

14. The learning model construction device according to claim 13, wherein size, format, shape, and rotation of the image data are changed by the data processing unit; and
the data processing unit generates a plurality of images by dividing the image indicated by the image data, such that the plurality of images is used as the teacher data.

15. The learning model construction device according to claim 1, wherein the plurality of learning units each learns a plurality of learning models, and each of learning verification images differs from the learning image and the optimal verification image, in which the true value of the scale is known.

16. The learning model construction device according to claim 15, wherein each of the plurality of the learning unit learns deep learning model, and learns the learning image indicated by the image data and the true value of the scale, and
the learning unit convolves the learning verification image to calculate the estimated scale value.

17. The learning model construction device according to claim 16, wherein the learning unit adjusts a weight parameter to calculate the loss value based on the true value and the estimated value of the learning verification image such that the weight parameter becomes a lowest value.

18. The learning model construction device according to claim 1, wherein a data restoration unit processes divided image to restore an unknown image before the division; and
sets a representative value of an estimated scale value calculated for each of the divided images as an estimated scale value of the unknown image represented by the restored image data.

19. The learning model construction device according to claim 18, when a size of the unknown image indicated by the image data is accepted as an input, the data restoration unit restores image size of the unknown image before the division to the accepted input size.

20. The learning model construction device according to claim 1, wherein an output unit outputs scale estimation information comprising the image data and the estimated scale value of the image indicated by the image data to a display and a data storage device.

21. The learning model construction device according to claim 1, wherein the scale is estimated with high accuracy by selecting the optimal learning model comprising the highest correlation with the true value constructed using the plurality of loss functions.
